(19) United States
(12) Patent Application Publication
(10) Pub. No.: US 2024/0382917 A1
(43) Pub. Date: Nov. 21, 2024

(54) METHOD FOR PRODUCING ABSORBENT FIBER-BASED GRANULATE WITH PELLET-LIKE UNITS AND DEVICE FOR CARRYING OUT THE METHOD

(71) Applicant: CATOLET GmbH & Co. KG, Albbruck (DE)

(72) Inventor: Uwe Baumgartner, Laufenburg-Luttingen (DE)

(73) Assignee: CATOLET GmbH & Co. KG, Albbruck (DE)

(21) Appl. No.: 18/692,938

(22) PCT Filed: Sep. 19, 2022
(86) PCT No.: PCT/EP2022/075891

§ 371 Date: Mar. 18, 2024

(30) Foreign Application Priority Data
Sep. 28, 2021 (CH) CH070323/2021

(51) Int. Cl. B01J 2/22; B01J 2/20; B30B 11/22; B30B 15/30

(52) U.S. Cl. CPC B01J 2/22; B01J 2/20; B30B 11/228; B30B 15/308

(57) ABSTRACT

A method for producing absorbent, fiber-based, in particular cellulose fiber-based, granular material as pellet-like units, wherein fiber-based starting-material parts are pressed through a granulating channel having a feed region, a compaction region and a loosening region and are crushed between two rollers. A device for carrying out the method is also disclosed.

### CROSS-REFERENCE TO RELATED APPLICATIONS

This application is a 371 National Phase of International Application No. PCT/EP2022/075891, filed Sep. 19, 2022, which claims priority to Swiss Patent Application No. CH070323/2021, filed on Sep. 28, 2021, both of which are incorporated herein by reference as if fully set forth.

### TECHNICAL FIELD

The invention relates to a method for producing absorbent, fiber-based granular material from fiber-based starting material. The invention also relates to a device designed to carry out the method.

### BACKGROUND

Absorbent granular material is typically used where liquids are to be bound. For example, absorbent granular material is used to prevent contamination and accidents owing to spilled oil or spilled chemicals. Absorbent granular material is also used for the cleaning of surfaces after accidents in which oil or chemicals have been spilled. Absorbent granular materials, however, are also used where liquids are to be bound in order to reduce odor emissions, for example in green-waste containers or at locations where pets leave excrement.

Such an absorbent granular material must be capable of absorbing as much liquid as possible in a short period of time. Furthermore, such a granular material must be able to flow readily, in order that it can be easily metered and easily evenly distributed at the location of use. The ability to flow readily also contributes to the granular material feeling pleasant for the user. The user may be a person who dispenses the granular material by hand or a pet which comes into contact with the granular material, for example when it runs on the granular material or moves on the granular material. Furthermore, it is advantageous when a state in which the granular material has bounded liquid can be identified on the granular material. Furthermore, it is advantageous when absorbent granular material in the state in which it has bounded liquid can be easily replaced with fresh granular material.

Absorbent granular materials that have these properties are known. Typically, such granular materials comprise units, for example particles, particulate materials, grains, rods, pellets, etc. having an inorganic composition. These units have a certain porosity and are able to absorb and bound liquid through the pores. Typically, the visual appearance of the granular material also changes with the absorption and bounding of liquid, and this makes the state in which the granular material has bounded liquid identifiable. Typically, the units are also of such a kind that they adhere to one another in the state in which they have absorbed liquid, with the result that it becomes easy to replace it with fresh granular material.

Absorbent granular materials comprising units of inorganic composition have the disadvantage that the granular material has a high apparent density. The high apparent density of the granular material makes it complex to transport and apply. It is also possible to improve the absorptivity per unit weight of the granular material only to a limited extent owing to the high weight of the granular material. Since the weight of the bounded liquid is added to the weight of the inorganic granular material, it is also difficult to transport and to replace it with fresh granular material. Another disadvantage of inorganic absorbent granular materials is that the use of these granular materials causes the generation of fine dust, which can constitute a risk to the user's health. There are further disadvantages in connection with the disposal of inorganic absorbent granular materials, since the disposal is resource-intensive and used granular material is rarely recycled, and it would also be resource-intensive to recycle it.

Absorbent granular materials that comprise units having an at least largely organic composition are also known. For example, such units may comprise cellulose fibers as main constituent. For production purposes, typically a starting material that provides the cellulose fibers, for example wood, paper, milled corncobs, chopped strands, etc. is pressed by means of a pelleting press to form pellets. Such units have a considerable hardness and are also compacted to a considerable degree. Therefore, such organic granular materials often have the disadvantage that they can absorb liquid only very slowly and also only in a small amount in relation to their weight. Furthermore, such granular materials also do not feel pleasant for the user owing to the considerable hardness and possible edges on the units.

### SUMMARY

An object of the invention is therefore to provide a method which enables the production of absorbent, fiber-based granular material comprising pellet-like units, the granular material having improved absorptivity.

An object of the invention is in particular to provide a method which enables the production of such a granular material which can bound a large amount of liquid in a very short period of time.

An object of the invention is in particular to provide a method which enables the production of such a granular material with a low apparent density.

An object of the invention is in particular to provide a method which enables the production of such a granular material which has a high specific absorptivity.

An object of the invention is in particular to provide a method which enables production of such a granular material substantially without residue.

An object of the invention is in particular to provide a method which enables the production of such a granular material which is able to flow readily and comprises units which feel pleasant for a user.

Another object of the invention is in particular to provide a method which enables the production of such a granular material which can be disposed of in a way which conserves resources.

An object of the invention is also to provide a device which makes it possible to carry out the method.

This object is achieved by a method having one or more of the features disclosed herein and by a device having one or more of the features disclosed herein.

The invention relates to a method for producing absorbent, fiber-based, in particular cellulose fiber-based, granular material comprising pellet-like units, comprising the following method steps:
fragmenting the starting material into fiber-based starting-material parts of defined size,
loosening and mixing the fiber-based starting-material parts,
pressing loosened and mixed starting-material parts through a granulating channel in a die in a pressing direction, which granulating channel
   forms an open channel through the die, and comprises
   a feed region,
   a compaction region, and
   a loosening region
in the die, wherein the regions are shaped, arranged and connected to one another in such a way that, when being pressed through the granulating channel, loosened and mixed starting-material parts
are guided via the feed region to the compaction region,
are compacted in the compaction region,
are subsequently loosened in the loosening region, and
are pressed to form a granular material comprising pellet-like units, in particular with a substantially cylindrical shape, and
crushing the granular material between rotating rollers and by means of the rotating rollers, in particular so that the respective pellet-like units are loosened by the crushing.

The fiber-based granular material largely comprises cellulose fibers, derivatives thereof, organic fibers, pulp, natural fibers or biofibers. These fibers present in the granular material to a large extent are of natural origin. This makes it possible to dispose of used granular material in a resource-conserving way, for example by means of composting or combustion, it being possible for the combustion to take place substantially without residue.

Furthermore, owing to its composition, such a granular material has a low apparent density, for example in comparison with granular materials comprising inorganic pellet-like units.

Furthermore, owing to the low apparent density, such a granular material has, among other things, a high specific absorptivity.

The fiber-based starting material may be cellulose fiber-based, pulp-based, organic fiber-based, natural fiber-based or biofiber-based. Such fiber-based starting material typically accumulates as waste in paper production, for example in the production of paper towels, napkins and tablecloths or in the production of handkerchiefs, care wipes, etc. As a result, these substances, which are normally disposed of directly, are provided with a further life cycle.

The fiber-based starting material may be present, for example, in the form of compact, ball-like units.

The starting material may be fragmented by means of cutting up, tearing up or tearing apart the starting material, so that afterwards parts of the fiber-based starting material of defined size are present. The fragmentation may be effected, for example, by means of rotating cutters or a shredder device. The defined size may relate to a maximum size, and therefore fiber-based starting-material parts that do not exceed the maximum size are present. This generates a further processible and uniform shape of the starting material.

The loosening and mixing of the fiber-based starting-material parts also contributes to generating the further processible and uniform shape of the starting material and at the same time makes it possible to add further starting material. The further starting material may also be of a different kind than the fiber-based starting material and provide, for example, a specific function. The further starting material may, for example, provide the function of a binder and be added in controllable amounts for this.

The loosening and mixing may be effected, for example, by means of an air stream, by means of vibration or by transporting the fiber-based starting-material parts on a conveyor belt.

During the mixing, the fiber-based starting material, or the fiber-based starting material and the further starting material, can be moistened, wherein the moistening can be effected by means of water.

The starting-material parts loosened and mixed in this way are fed to a press. Such a press may be, for example, a pelleting press. The press then presses the loosened and mixed starting-material parts through the granulating channels in a die. The pressing can be effected, for example, by means of rotating rollers.

The feed of the loosened and mixed starting-material parts to the press and the pressing are effected such that pellet-like units emerge from the granulating channels. The feed is continuous. The pressing through the granulating channels is effected such that no continuous material strand emerges from the granulating channels, but rather the pellet-like units emerge directly. For example, a rotating roller rolls over a granulating channel while pressing takes place and then the granulating channel is exposed by the roller, until a point in time at which a roller rolls over the granulating channel again. In the state in which the granulating channel is exposed, no pressing takes place.

The feed region of the granulating channel is shaped such that the loosened and mixed starting-material parts are fed to the compaction region and no substantial compaction takes place during the feeding operation. This compaction is then effected upon entry or at the transition from the feed region to the compaction region. That is to say, the loosened and mixed starting-material parts undergo gradual compaction or continuous compaction in stages and are not compacted abruptly, as is the case with conventional granulating channels, which do not have a feed region but only a compaction region, for example a cylindrical bore. The compaction region may be, for example, a cylindrical bore.

Similarly, the loosening region of the granulating channels is shaped such that the compacted starting-material parts undergo spreading-out or loosening upon exit or at the transition from the compaction region to the loosening region. The loosening region is shaped such that this spreading-out or loosening takes place gradually or continuously in stages and not abruptly, as is the case for conventional granulating channels, which do not have a loosening region.

The pellet-like units emerging from the granulating channels have thus, after compaction in the compaction region, undergone loosening in the loosening region for the first time.

The pellet-like units, or the granular material, is fed to the rotating rollers.

Typically, the rollers are aligned horizontally and rotate about respective horizontal axes.

The rollers are typically at a spacing from one another, so that there is a gap between the rollers.

The feed to the rollers can be effected in that the granular material is dropped into the gap between the rollers. For example, the granular material may be scattered/poured by being dropped into the gap from a conveyor belt.

The pellet-like units are crushed between the rollers such that there is no appreciable compaction, but rather the pellet-like units undergo loosening for the second time. The loosening is achieved by breaking down the pellet-like units, in particular breaking down a compacted skin or a compacted surface region of the pellet-like units.

Since loosening is performed for a first and a second time after the compaction, access to regions of the pellet-like units that take in liquid is facilitated, or more such regions are made more easily accessible to a liquid that is to be taken in or absorbed, the result of which is improved absorptivity. Expressed differently, an increase in size of the surface area via which liquid can be taken up/absorbed is connected with the loosening.

Furthermore, highly compacted pellet-like units have reduced absorptivity, among other things also because a high degree of compaction greatly reduces the speed at which a liquid can be taken in or absorbed. Therefore, the first and second loosening leads to improved absorptivity of the pellet-like units of the granular material.

Furthermore, the first and second loosening leads to pellet-like units which are able to flow readily and feel pleasant for a user.

According to one embodiment of the method, the feed region narrows in the pressing direction, and in particular is funnel-shaped or conical, and/or the feed region and the loosening region are connected to one another via the compaction region, and/or the granulating channel narrows to the greatest extent in the compaction region, and/or the loosening region widens in the pressing direction, and in particular is funnel-shaped or conical.

According to one embodiment of the method, the rollers rotate in the same direction, and at the same rotational speeds or at rotational speeds that are different from one another, with respect to the granular material.

In the same direction refers to the direction of movement of the granular material guided between the rollers. If the granular material is scattered/poured, for example by being dropped between the rollers, the granular material moves in the direction of gravitational force. The rollers then rotate in the opposite direction to the direction of gravitational force with respect to the region where the crushing happens. That is to say, the surfaces of the rollers move in the direction of gravitational force, or in the direction of the falling granular material, in the region where the crushing happens.

The rotational speeds that are different from one another have the effect that the pellet-like units experience shear forces, as a result of which the pellet-like units are pulled apart and thus loosening, and in connection with this an increase in size of the surface area via which liquid can be taken up/absorbed, is effected.

According to one embodiment of the method, to crush the granular material, the pellet-like units are guided between the rollers by means of grooves in one roller surface, in particular in both roller surfaces.

According to one embodiment of the method, it comprises the following method step: combining loosened and mixed starting material parts to form agglomerates, wherein the granular material is obtained by pressing the agglomerates through the granulating channel.

This can have the effect that the material is fed to the press continuously but in distinct portions.

The combining can also be effected, for example, by pushing together or piling up the loosened and mixed starting material parts.

According to one embodiment of the method, it comprises the following method step: wetting the fiber-based starting material parts with water.

Wetting can be effected, for example, by means of a spray mist. This makes it possible to control, for example, properties of the loosened and mixed starting material parts, like the adhesion to one another and/or sliding in the granulating channel.

According to one embodiment of the method, the fragmentation comprises the following method steps:
coarsely fragmenting the starting material into fiber-based starting-material parts of undefined size,
finely fragmenting the fiber-based starting-material parts of undefined size into the fiber-based starting-material parts of defined size,
wherein the defined size relates to a size threshold value, so that the defined size corresponds to this size threshold value or is less than this size threshold value.

According to one embodiment of the method, it comprises the following method step: drying the granular material and crushing the dried granular material between and by means of the rotating rollers, in particular so that the dried granular material is loosened by the crushing.

The drying can be effected, for example, by means of a warm air stream.

According to one embodiment of the method, it comprises the following method step: separating the granular material from loose, fiber-based material.

The loose, fiber-based material (waste), such as fiber dust, that is produced or accumulates at different locations during production can be collected, for example by means of suction extraction/filtration or catching. The loose, fiber-based material collected in this way can then in turn be fed to the production process. This makes it possible to produce the granular material substantially without residue.

According to one embodiment of the method, it comprises the following method step: adding loose, fiber-based material that accumulates during the method to the fiber-based starting material and/or to fiber-based starting-material parts.

According to one embodiment of the method, it comprises the following method step: adding at least one additive, from the following list of additives: fragrance, odor binder, disinfectant, surface- or interface-active substance, bentonite, and chalk.

The invention also relates to a device for producing absorbent, fiber-based, in particular cellulose fiber-based, granular material comprising pellet-like units by a method according to the invention, comprising
a receptacle for fiber-based starting material,
a fragmenting device, designed to fragment the starting material into fiber-based starting-material parts of defined size,
a mixing device, designed to loosen and mix fiber-based starting-material parts, and
a press having
   a die, which has a granulating channel, which granulating channel
      forms an open channel through the die, and comprises
      a feed region,
      a compaction region, and
      a loosening region
in the die, wherein the regions are shaped, arranged and connected to one another in such a way that, when being pressed through the granulating channel in a pressing direction, loosened and mixed starting-material parts
   are guided via the feed region to the compaction region,
   are compacted in the compaction region,
   are subsequently loosened in the loosening region, and
   are pressed to form a granular material comprising pellet-like units, in particular with a substantially cylindrical shape, wherein
the feed region narrows in the pressing direction,
the feed region and the loosening region are connected to one another via the compaction region,
the granulating channel narrows to the greatest extent in the compaction region,
the loosening region widens in the pressing direction, and
the device comprises a crushing device with rotatable rollers, which is designed to crush the granular material between and by means of the rotatable rollers, in particular such that the respective pellet-like units are loosened by the crushing.

The receptacle may be, for example, a collecting funnel which receives the fiber-based starting material and feeds it to the fragmenting device by virtue of its shape. The receptacle may also be a conveyor belt, which receives the fiber-based starting material and feeds it to the fragmenting device.

The fragmenting device may be, for example, a shredder device or a device with rotating cutters.

The mixing device may be, for example, a blower or an agitating/shaking system or a vibrating system. The function of the mixing device may also be performed by the nature of the transport of the fiber-based starting-material parts.

The press may be a press of the pelleting press type, comprising a die and rollers, which press the loosened and mixed starting-material parts through the die.

The fiber-based starting material, the loosened and mixed starting-material parts and the granular material are typically transported by means of conveyor belts during production.

According to one embodiment of the device, the feed region is funnel-shaped, in particular conical, and/or the loosening region is funnel-shaped, in particular conical.

According to one embodiment of the device, the rollers are configured to rotate in the same direction, and at the same or different rotational speeds relative to one another, with respect to the granular material, in particular the rollers rotate in the same direction, and at rotational speeds that are different from one another, with respect to the granular material.

According to one embodiment of the device, grooves designed to guide the pellet-like units between the rollers to crush the granular material are formed in one roller surface, in particular in both roller surfaces.

### BRIEF DESCRIPTION OF THE DRAWINGS

The method according to the invention and the device according to the invention are described in more detail below purely by way of example and with reference to embodiments illustrated more specifically in the figures. In the figures:

FIG. 1 shows a schematic illustration of a section through a granulating channel according to the invention, loosened and mixed starting-material parts, compacted starting-material parts, a pellet-like unit and a roller, which presses loosened and mixed starting-material parts through the granulating channel; and

FIG. 2 shows a schematic illustration of two rotating rollers and pellet-like units, which are crushed between the rollers.

### DETAILED DESCRIPTION

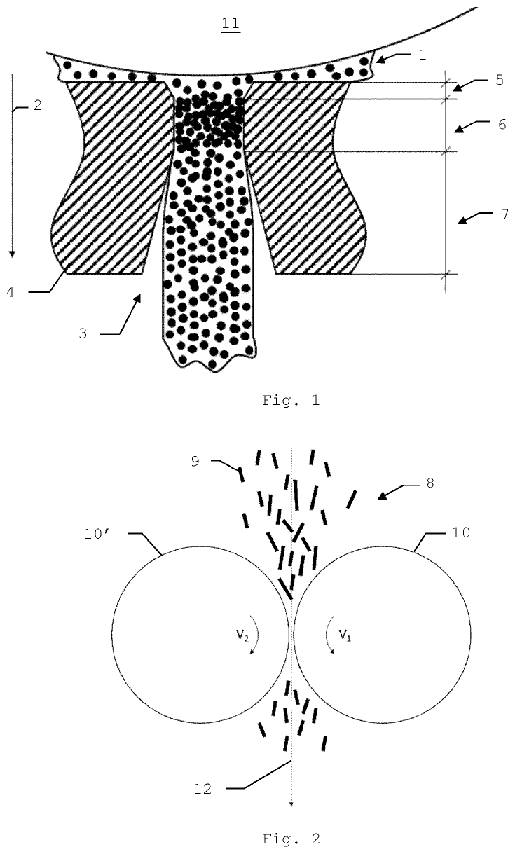

FIG. 1 shows a purely schematic sectional illustration of a granulating channel 3 according to the invention. The granulating channel 3 is arranged in a die 4 and forms a channel through the die. FIG. 1 also shows a purely schematic sectional illustration of loosened and mixed starting-material parts 1, which are pressed through the granulating channel 3 by a roller 11, for example in the form of a pan grinder, of the press. In this figure, the black dots serve to purely schematically depict the ratios of compaction in the different regions.

The granulating channel 3 shown in FIG. 1 comprises the following, arranged one behind another in the pressing direction 2: a feed region 5, a compaction region 6, and a loosening region 7. This feed region 5 is conical, narrows in the pressing direction 2 and feeds the loosened and mixed starting-material parts 1 to the compaction region 6. The feed region 5 may also be funnel-shaped or tapered. The feed region 5 has the effect that loosened and mixed starting-material parts are fed from a first region of spatially greater extent, via a specific path, to the compaction region 6 of spatially lesser extent.

The compaction region 6 shown in FIG. 1 is substantially cylindrical. The compaction region 6 is that region of the granulating channel 3 that narrows the granulating channel to the greatest extent.

The loosening region 7 shown in FIG. 1 is conical and widens in the pressing direction 2, and gives the compacted starting-material parts space to spread out via a specific path. As a result, the degree of compaction prevailing in the loosening region 7 is less than that prevailing in the compaction region. The pellet-like unit 9 emerges from the granulation channel 3.

FIG. 2 shows a purely schematic illustration of two rotating rollers 10, 10′ between which the falling granular material 8, or the falling pellet-like units 9, are crushed. The crushing leads to a more uniform shape/form/geometry of the pellet-like units 9 and to these very units breaking down, substantially without bringing about compaction. The two rollers 10, 10′ are at a spacing from one another and are rotatable about a respective horizontal axis. The rollers 10, 10′ rotate in the same direction and at the same or different rotational speeds V1 and V2 with respect to the falling direction 12 of the granular material 8, or in the direction of gravitational force.

One or both roller surfaces may have grooves, which guide the falling granular material evenly between the rollers.

1. A method for producing absorbent, fiber-based, granular material comprising pellet-shaped units, the method comprising the following steps:
providing a fiber-based starting material,
fragmenting the starting material into fiber-based starting-material parts of defined size,
loosening and mixing the fiber-based starting-material parts,
pressing the loosened and mixed starting-material parts through a granulating channel in a die in a pressing direction, said granulating channel
forms an open channel through the die, and comprises
a feed region,
a compaction region, and
a loosening region
in the die, wherein the feed, compaction, and loosening regions are shaped, arranged and connected to one another such that, when being pressed through the granulating channel, the loosened and mixed starting-material parts
are guided via the feed region to the compaction region,
are compacted in the compaction region,
are subsequently loosened in the loosening region, and
are pressed to form a granular material comprising pellet-shaped units,
and
crushing the granular material between rotating rollers and by action of the rotating rollers.

2. The method as claimed in claim 1, wherein at least one of:
the feed region narrows in the pressing direction,
the feed region and the loosening region are connected to one another via the compaction region,
the granulating channel narrows to a greatest extent in the compaction region, or
the loosening region widens in the pressing direction.

3. The method as claimed in claim 1, wherein the rollers rotate in a same direction, and at different rotational speeds relative to one another, with respect to the granular material.

4. The method as claimed in claim 1, wherein, to crush the granular material, the pellet-shaped units are guided between the rollers by grooves in at least one roller surface.

5. The method as claimed in claim 1, further comprising the following method step: combining the loosened and mixed starting material parts to form agglomerates, and the granular material is obtained by pressing the agglomerates through the granulating channel.

6. The method as claimed in claim 1, further comprising the following method step: wetting the fiber-based starting materials with water.

7. The method as claimed in claim 1, wherein the fragmentation comprises the following method steps:
coarsely fragmenting the starting material into fiber-based starting-material parts of undefined size,
finely fragmenting the fiber-based starting-material parts of undefined size into the fiber-based starting-material parts of defined size,
wherein the defined size relates to a size threshold value, so that the defined size corresponds to a size threshold value or is less than the size threshold value.

8. The method as claimed in claim 1, further comprising the following method step: drying the granular material and crushing the dried granular material between and by means action of the rotating rollers.

9. The method as claimed in claim 1, further comprising the following method step: separating the granular material from loose, fiber-based material.

10. The method as claimed in claim 1, further comprising the following method step: adding loose, fiber-based material that accumulates during the method to at least one of the fiber-based starting material or to fiber-based starting-material parts.

11. A device for producing absorbent, fiber-based, granular material comprising pellet-shaped units, the device comprising
a receptacle for fiber-based starting material,
a fragmenting device, designed to fragment the starting material into fiber-based starting-material parts of defined size,
a mixing device, designed to loosen and mix fiber-based starting-material parts, and
a press having
a die, which has a granulating channel, said granulating channel
forms an open channel through the die, and comprises
a feed region,
a compaction region, and
a loosening region
in the die, wherein the feed, compaction, and loosening regions are shaped, arranged and connected to one another such that, when being pressed through the granulating channel in a pressing direction, loosened and mixed starting-material parts
are guided via the feed region to the compaction region,
are compacted in the compaction region,
are subsequently loosened in the loosening region, and
are pressed to form a granular material comprising pellet-shaped units,
wherein
the feed region narrows in the pressing direction,
the feed region and the loosening region are connected to one another via the compaction region,
the granulating channel narrows to a greatest extent in the compaction region,
the loosening region widens in the pressing direction, and
a crushing device with rotatable rollers is adapted to crush the granular material between and by means action of the rotatable rollers.

12. The device as claimed in claim 11, wherein
the feed region is funnel-shaped.

13. The device as claimed in claim 11, wherein
the loosening region is funnel-shaped.

14. The device as claimed in claim 11, wherein the rollers are configured to rotate in a same direction, and at different rotational speeds relative to one another, with respect to the granular material.

15. The device as claimed in claim 11, wherein grooves designed to guide the pellet-shaped units between the rollers to crush the granular material are formed in at least one roller.
